(19) United States
(12) Patent Application Publication
(10) Pub. No.: US 2003/0135431 A1
(43) Pub. Date: Jul. 17, 2003

(54) Linking ORC life tracking/usage with inventory management

(75) Inventors: Thomas Leonard Schwartz, Fairport, NY (US); Richard Robert Tilney Carling, Lakeville, NY (US)

Correspondence Address: Lawrence P. Kessler, Patent Department, NexPress Solutions LLC, 1447 St. Paul Street, Rochester, NY, 14653-7103, US

(73) Assignee: NexPress Solutions LLC

(21) Appl. No.: 10/028,000

(22) Filed: Dec. 20, 2001

(51) Int. Cl. G06F 17/60

(52) U.S. Cl. 705/28

(57) ABSTRACT

An inventory management system and method that allows an operator to manage an inventory for a system that has at least one piece of serviceable equipment with a plurality of replaceable components, wherein each of the replaceable components has an expected lifetime based on a predetermined criteria which the an inventory management system observes via an inventory tracking system that uses parameters of expected use and predicted remaining life of the replaceable components to determine to manage the inventory.

### FIELD OF THE INVENTION

The present invention relates to inventory management using databases, and more particularly, to inventory management of serviceable equipment having Operator Replaceable Components.

### BACKGROUND OF THE INVENTION

The concept of inventory management has been applied to various types of products by numerous systems. Among these are “point of sale” systems that are common within super markets. Typically, “point of sale” systems are used to inventory products offered for sale that are identified with an identifiable indicia, such as a bar code. Upon being purchased, the bar code for the product is scanned and the purchase is recorded. Additionally, the “point of sale” system inventories the products once they are purchased and itemizes the number of each individual product item that is sold for accounting purposes. “Point of sale” systems also provide assistance in accounting and taxes. While “point of sale” systems are useful for keeping inventory of products that can be individually scanned upon the sale of the product, the usefulness of “point of sale” systems is limited to stores that move through inventory in relatively large numbers. In terms of inventory management, the usefulness of “point of sale” systems is limited to products that can be scanned at the time of purchase in order to perform inventory management. The “point of sale” concept provides no usefulness for maintaining inventory in systems having parts that periodically need to be replaced.

A prior art teaching contained in U.S. Pat. No. 6,154,728 issued to Sattar et al. (Sattar) discloses that the inventory management and control of many field replaceable units can be accomplished in a distributed inventory management scheme. Sattar requires that the field replaceable units input a status that can be tracked by the distributed inventory management system. Sattar requires that the field replaceable units must report a status as non-functional in order for the distributed inventory management system to understand that the inventory needs modification for that non-functional field replaceable unit. Therefore, the field replaceable unit must actually break down and the system that the field replaceable unit is in will, accordingly, also break down. Therefore, Sattar has a shortcoming in that it does not teach an inventory management system that can predict inventory needs prior a breakdown of the replaceable parts within the system.

Numerous complicated systems that wear during normal use exist within the prior art. These systems require periodic maintenance to replace worn components. Typically, these complicated systems require service professionals such as field service engineers to repair or replace the components in these systems that wear during periods of normal use. In a number of these complicated systems, the period of time that the system is not working or, working at less than optimum performance, is critical. For many of these systems, it is intended to keep the system running continuously. A digital printing system is one such system. Minimizing down time is critical to the owners and operators of digital printers.

The prior art has recognized that it is important to count the number of uses that are applied to printing devices. One such prior art reference, U.S. Pat. No. 5,383,004 issued to Miller et al. (Miller), discloses a method and apparatus for normalizing the counting of sheets that are printed to compensate for varying sizes of sheets that are printed and provide a more accurate record of the wear on components within the system. However, Miller does not teach a system that will provide the operator with the specific knowledge of the wear on the components within the system, thus enabling the operator with the ability to perform maintenance on the system at optimum times. By not providing optimum timing for replacement of components that wear during normal use, the resulting prints are not assured of being of optimum quality. Therefore, the teachings of Miller have a shortcoming in that the operator is not made aware of the current condition of the numerous parts within a printing system that will wear during use.

One solution that has been presented is embodied in U.S. patent application Ser. No. 09/166,326 filed in the name of Burgess (Burgess), commonly assigned with the present invention. Burgess describes a Service Publication System that provides service related information in the form of Field Replaceable Units (FRUs). Burgess is useful in providing service related information for field service engineers and the like, by providing service diagnostics and browser enabled publications. However, Burgess relates to a system that is strictly intended to be used by field engineers and field service representatives and does not provide a system that can be maintained by the operator. While this system of Burgess is useful in providing data for a field engineer, it does not provide operators with the ability to perform maintenance without the service of a field service representative. Therefore, on sight maintenance for sophisticated systems is not enabled by the system taught by the Burgess application. Furthermore, Burgess does not perform any type of automated predictor to determine component life. Moreover, it does not teach how to maintain replacement history and calculate a new life expectancy from that replacement history. Therefore, on sight maintenance and on sight predicting maintenance lifetimes of components for sophisticated systems is not enabled by the system taught by the Burgess application.

In view of the foregoing discussion there remains a need within the prior art for an operator controlled inventory management system that can anticipate inventory requirements without having system components break down and without requiring the services of field service representatives.

### SUMMARY OF THE INVENTION

An inventory management system and method that allows an operator to manage an inventory for a system that the inventory serves, the system has at least one piece of equipment with a plurality of replaceable components, each of the replaceable components has an expected lifetime based on a predetermined criteria which the inventory management system is coupled to receive data relative to the replaceable components relative to the tracking system.

The present invention addresses the aforementioned needs within the prior art by providing an inventory management system employing a single database to manage the inventory of multiple Operator Replaceable Components for serviceable equipment. The inventory management as envisioned by the present invention details and records remaining life information related to Operator Replaceable Components by recording the use, and the types of use, for which these Operator Replaceable Components are employed. Critical thresholds for the remaining life of the Operator Replaceable Components can be customized and used for the inventory management for multiple machines. The inventory database can be used for the automated creation of an Operator Replaceable Component (ORC) reorder sheet and operator notification when it is time to replace components that have used their expected life.

### BRIEF DESCRIPTION OF THE DRAWINGS

FIG. 1 is a perspective view of the system containing the preferred embodiment of the invention;

FIG. 2 is an illustration of an operator replacing an ORC within the system;

FIG. 3 is an illustration of the graphical user interface displaying the life tracking of ORC devices within the system of FIG. 1;

FIG. 4 is a flowchart that details the operations that are performed by the system of the present invention;

FIG. 5 is a block diagram illustrating the pieces of equipment used in the preferred embodiment of the inventory management of the invention;

FIG. 6 is an illustration of the screen that is presented for part details of a specific ORC within inventory;

FIG. 7a is an illustration of a screen that is presented for adjusting the inventory quantity for a specific ORC;

FIG. 7b is an illustration of a screen that is presented for adjusting details for a specific ORC within inventory once that ORC has been received and has to be entered into inventory;

FIG. 7c is an illustration of a screen that is presented for adjusting the reorder details for a specific ORC within inventory; and

FIG. 8 is an illustration of a screen that is presented for calculating ORC reorder levels.

### DETAILED DESCRIPTION OF THE PREFERRED EMBODIMENTS

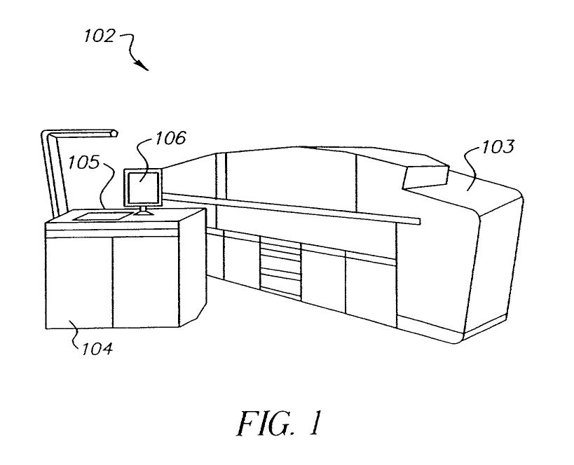

Referring to FIG. 1, which is an illustration of a system 102 as envisioned by the preferred embodiment of the present invention, a digital printer 103 is designed and configured with Operator Replaceable Component (ORC) devices that enable a typical operator to perform the majority of maintenance on the system without requiring the services of a field engineer. Digital printer 103, in the preferred embodiment, is a NexPress®2100, however, the present invention pertains to systems in general and digital printing systems in particular. The preferred embodiment as illustrated in FIG. 1 includes in system 102 a user interface 104 which in the preferred embodiment is a NextStation™ adjacent to the NexPress®2100, however in general, virtually any interactive device can function as user interface 104, and specifically any Graphics User Interface (GUI) can function as user interface 104 as employed by the present invention. The ORC devices as envisioned by the present invention are those components within systems that become worn after periods of use. Specifically, the ORC devices as envisioned by the preferred embodiment herein, are those components used within digital printing systems that wear with use. These ORC devices within the preferred embodiment have predictable lifetimes that can be anticipated by parameters relative to the use of the digital printer 103. Therefore, it is possible to anticipate when these ORC devices will need to be replaced before the wear on them results in less than desirable performance in the system 102.

System 102 has multiple computational elements. The digital printer 103 is provided with computational devices, the most notable computational element within digital printer 103 referred to, herein, as the Digital Front End (DFE). The NextStation™ provides a computational element 105 having a Graphical User Interface (GUI) 106 that interfaces with a database management system within the DFE. It should be understood that while the preferred embodiment details a system 102 with a digital printer 103 having at least one computational element which interfaces and another computational element associated with GUI 106, similar systems can be designed with more computational elements or fewer computational elements, and that these variations will be obvious to those skilled in the art. In the preferred embodiment, GUI 106 on the NextStation™ provides the operator with the ability to view the current status of ORC devices on the NexPress®2100 digital printer 103 and to perform maintenance in response to maintenance information provided on the graphical display on GUI 106 as well as to alerts that are provided from the DFE.

The database management system will receive data for each of the ORC devices that details the usage of each of the ORC devices based on the number of prints made, the types of paper being used, the color composition of the printed pages as well as various sensor inputs. The database management system then takes the received data and creates a life tracking system that keeps track of the remaining life of the ORC devices and informs the operator via the GUI 106. The preferred embodiment employs tables displayed on the GUI 106 to inform the operators to the current status of the ORC devices. However, it should be noted that numerous variations are possible including, but not limited to, direct messages related to a single ORC device, various types of alarms, or even graphical messages on the GUI 106. The database management system will also prompt the operator when any of the ORC devices need to be replaced. The digital printing system of the present invention provides tracking of the ORC devices in an ORC tracking table along with an automated transmission of the ORC Tracking Table to the GUI 106. The preferred embodiment of the present invention uses page count and parameters related to customer usage to create the ORC tracking chart. The concepts embodied by the present invention empower the operator with the ability of performing maintenance on a sophisticated digital press. When an operator replaces an ORC, the life counter for that ORC is reset. Table 1 below illustrates a tracking table for ORC devices that would typically be provided on GUI 106 within the preferred embodiment of the invention.

TABLE 1

| Catalog | | Average | Remaining | Replaced | Machine |
|---|---|---|---|---|---|
| Number | Description | Life | Life | Qty. | Qty. |
| *21004 | NexPress DryInk, Black | 12,500 | 23 | 56 | 1 |
| 21054 | Pressure Roller Cleaner | 40,000 | 312 | 17 | 1 |
| | Sheet | | | | |
| *21001 | NexPress DryInk, Cyan | 25,000 | 2,852 | 28 | 1 |
| *21002 | NexPress DryInk, | 25,000 | 3,257 | 28 | 1 |
| | Magenta | | | | |
| *21003 | NexPress DryInk, | 25,000 | 6,941 | 28 | 1 |
| | Yellow | | | | |
| 21026 | Contact Skive Finger | 45,000 | 8,190 | 120 | 8 |
| | General Press | 50,000 | 11,011 | 14 | 1 |
| | Maintenance | | | | |
| *21030 | Fuser Fluid | 100,000 | 13,063 | 6 | 1 |
| *21031 | Fuser Cleaning Web | 100,000 | 18,699 | 6 | 1 |
| 21032 | Transport Web | 100,000 | 18,699 | 6 | 1 |
| 21038 | Cleaning Web | 550,000 | 22,578 | 1 | 1 |
| 21063 | Cleaner Sump | 125,000 | 28,814 | 4 | 1 |
| *21051 | DryInk Collection Bottle | 135,000 | 34,125 | 5 | 1 |
| 21025 | Fuser Roller Ay | 150,000 | 39,002 | 4 | 1 |
| 21059 | Fuser Pads | 475,000 | 40,992 | 1 | 1 |
| 21029 | Donor Roller | 375,000 | 45,671 | 1 | 1 |
| 21061 | Metering Roller | 875,000 | 50,773 | 0 | 1 |
| 21060 | Metering Blade | 475,000 | 52,349 | 1 | 1 |
| | Perfector Belt | 200,000 | 55,891 | 3 | 1 |
| | Maintenance | | | | |
| 21027 | Pressure Roller | 200,000 | 56,129 | 3 | 1 |
| **21041 | Primary/PreClean Wire | 200,000 | 60,009 | 48 | 16 |
| **21042 | Conditioner/Tackdown | 200,000 | 61,892 | 33 | 11 |
| | Wire | | | | |
| **21036 | IC/BC Cleaning Blade | 200,000 | 63,167 | 24 | 8 |
| **21058 | Wiper Pads | 200,000 | 64,287 | 12 | 4 |
| **21044 | Narrow Primary Grid | 7,000,000 | 87,094 | 0 | 4 |
| **21045 | Wide Primary Grid | 3,000,000 | 87,094 | 0 | 8 |
| **21047 | Conditioning Charger | 1,000,000 | 91,075 | 1 | 2 |
| | Grid | | | | |
| **21050 | PreClean Grid | 2,000,000 | 91,075 | 0 | 4 |
| **21035 | IC/BC Cleaning Brush | 2,200,000 | 105,245 | 0 | 8 |
| **21039 | Imaging Cylinder | 230,000 | 105,245 | 3 | 4 |
| 21017 | Developer, Cyan | 300,000 | 220,145 | 3 | 1 |
| 21018 | Developer, Magenta | 300,000 | 220,145 | 3 | 1 |
| 21019 | Developer, Yellow | 300,000 | 220,145 | 3 | 1 |
| 21020 | Developer, Black | 300,000 | 280,569 | 3 | 1 |
| **21040 | Blanket Cylinder | 330,000 | 301,738 | 3 | 4 |
| 21064 | Water Filter Cartridge | 500,000 | 491,813 | 1 | 1 |
| 21055 | Fuser Lamp | 2,000,000 | 1,000,865 | 0 | 1 |
| **21074 | BC Charger | 1,800,000 | 1,100,865 | 0 | 4 |
| 21057 | Pressure Roller Lamp | 2,000,000 | 1,300,865 | 0 | 1 |
| **21043 | PreClean Charger | 2,000,000 | 1,300,865 | 0 | 4 |
| **21046 | Primary Charger | 2,000,000 | 1,300,865 | 0 | 4 |
| 21048 | Tackdown Charger | 2,000,000 | 1,300,865 | 0 | 1 |
| **21033 | Imaging Cylinder | 4,000,000 | 3,300,865 | 0 | 4 |
| | Cleaner | | | | |

Table 1 provides a list of ORC devices with the ORC devices having the shortest remaining life listed first. Each ORC device is given a catalog number to simplify the ordering process and a description to assist the operator with simple recognition of the ORC device. As readily apparent from Table 1, the ORC devices in Table 1 are listed in decreasing amounts of remaining life of the ORC devices

In Table 1, under the column heading Catalog Number, several of the items listed have a single asterisk (*) in the first position, before the actual Catalog Number. This asterisk (*) is not actually produced on the GUI 106 but is placed on Table 1 as shown to indicate the items that are not used by the preferred embodiment as ORC devices, but instead have sensors that detect when they must be replenished or replaced. The items in Table 1 having a single asterisk (*) before their Catalog Number generally indicate consumables such as DryInk or fluid. However, there are also items having a single asterisk (*) before their Catalog Number such as the Fuser Cleaning Web or the DryInk collection bottle that are not consumables in the general sense but use a sensor to detect if the items need to be replaced within the preferred embodiment. Since the indication that the replacement of items with a single asterisk (*) in front of their Catalog Number, is signified by a sensor rather than an expected life span, these items are not ORC devices within the context of the present invention. Therefore, even though the items with a single asterisk (*) before their Catalog Number will have an expected life span listed in the Remaining Life column, their respective object files will have the tracking feature from their expected life span disabled to prevent the tracking of those items with a single asterisk (*) before their Catalog Number. It should be noted that the items with a single asterisk (*) in front of their Catalog Number could be used as ORC devices within the context of the present invention simply by using the value for their expected life span as listed in the Remaining Life column to track the use of these items and indicate when they need to be replaced.

Additional information is provided on GUI 106 as illustrated in Table 1, such as Average Life of that specific type of ORC device, the Replaced Quantity which is the number of times that specific ORC device has been replaced, and Machine Quantity. The Machine Quantity is the physical number of times that a specific ORC exists within the system. The ORC devices that have an entry greater than one within the Machine Quantity column, represent ORC devices within the preferred embodiment that would have the tracking feature for their expected life span as listed in the Remaining Life column disabled by indicating that this feature be disabled within their respective object files. These ORC devices within the Machine Quantity column that have an entry greater than one, are indicated with a double asterisk (**) before their respective Catalog Numbers in Table 1 and could easily be employed by the invention as ORC devices with their remaining life tracked. However, they are not tracked by the preferred embodiment, because they can be interchanged and individual life predictions are difficult. The feature of the preferred embodiment of disabling the expected life tracking feature for those items with a double asterisk (**) before their respective Catalog Numbers in Table 1 is, therefore, a design feature of the preferred embodiment and could easily be altered to have the expected life tracking feature for the items with a double asterisk (**) before their respective Catalog Numbers enabled. Additional use of the columns of information in Table 1 will be discussed further below.

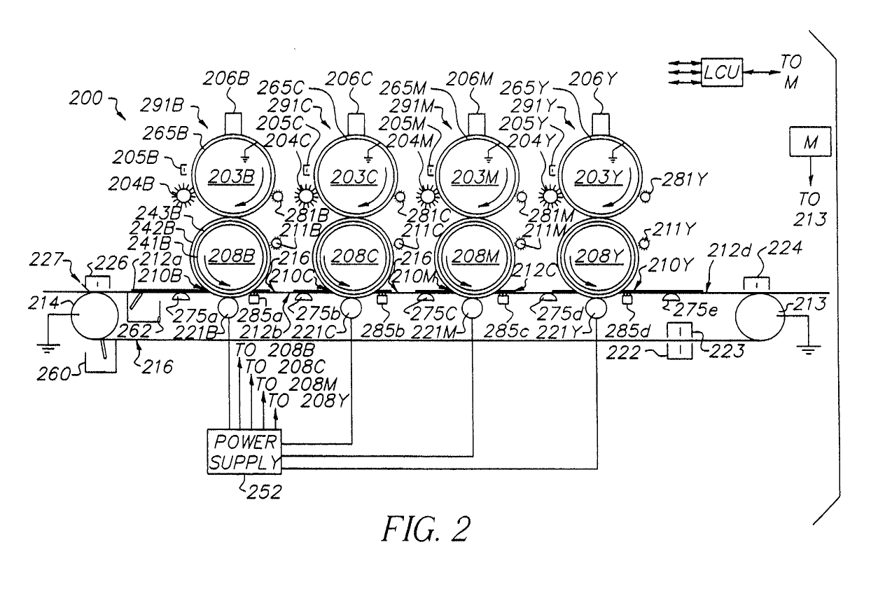

Referring now to FIG. 2 of the accompanying drawings, the area inside digital printer 103 is illustrated showing the image forming reproduction apparatus according to the preferred embodiment of the present invention, designated generally by the numeral 200. The reproduction apparatus 200 is in the form of an electrophotographic reproduction apparatus and more particularly a color reproduction apparatus wherein color separation images are formed in each of four color modules and transferred in register to a receiver member as a receiver member is moved through the apparatus while supported on a paper transport web (PTW) 216. The apparatus 200 illustrates the image forming areas for digital printer 103 having four color modules, although the present invention is applicable to printers of all types and more specifically to systems having components that wear with use. FIG. 2 illustrates a system having numerous parts that wear with use and must be periodically replaced.

The elements in FIG. 2 that are similar from module to module have similar reference numerals with a suffix of B, C, M and Y referring to the color module for which it is associated; black, cyan, magenta and yellow, respectively. Each module (291B, 291C, 291M, 291Y) is of similar construction. The paper transport web 216, which may be in the form of an endless belt, operates with all the modules 291B, 291C, 291M, 291Y and the receiver member is transported by the PTW 216 from module to module. Four receiver members, or sheets, 212a, b, c and d are shown simultaneously receiving images from the different modules, it being understood as noted above that each receiver member may receive one color image from each module and that in this example up to four color images can be received by each receiver member. The movement of the receiver member with the PTW 216 is such that each color image transferred to the receiver member at the transfer nip of each module is a transfer that is registered with the previous color transfer so that a four-color image formed on the receiver member has the colors in registered superposed relationship on the receiver member. The receiver members are then serially detacked from the PTW and sent to a fusing station (not shown) to fuse or fix the dry toner images to the receiver member. The PTW is reconditioned for reuse by providing charge to both surfaces using, for example, opposed corona chargers 222, 223 which neutralize the charge on the two surfaces of the PTW. These chargers 222, 223 are operator replaceable components within the preferred embodiment and have an expected life span after which chargers 222, 223 will require replacement.

Each color module includes a primary image-forming member (PIFM), for example a rotating drum 203B, C, M and Y, respectively. The drums rotate in the directions shown by the arrows and about their respective axes. Each PIFM 203B, C, M and Y has a photoconductive surface, upon which a pigmented marking particle image, or a series of different color marking particle images, is formed. The PIFM 203B, C, M and Y have predictable lifetimes and constitute operator replaceable components. The photoconductive surface for each PIFM 203B, C, M and Y within the preferred embodiment is actually formed on an outer sleeves 265B, C, M and Y, upon which the pigmented marking particle image is formed. These outer sleeves 265B, C, M and Y, have lifetimes that are predictable and therefore, are operator replaceable components. In order to form images, the outer surface of the PIFM is uniformly charged by a primary charger such as a corona charging devices 205B, C, M and Y, respectively or other suitable charger such as roller chargers, brush chargers, etc. The corona charging devices 205B, C, M and Y each have a predictable lifetime and are operator replaceable components. The uniformly charged surface is exposed by suitable exposure means, such as for example a laser 206B, C, M and Y, respectively or more preferably an LED or other electro-optical exposure device or even an optical exposure device to selectively alter the charge on the surface of the outer sleeves 265B, C, M and Y, of the PIFM 203B, C, M and Y to create an electrostatic latent image corresponding to an image to be reproduced. The electrostatic image is developed by application of pigmented charged marking particles to the latent image bearing photoconductive drum by a development station 281B, C, M and Y, respectively. The development station has a particular color of pigmented toner marking particles associated respectively therewith. Thus, each module creates a series of different color marking particle images on the respective photoconductive drum. The development stations 281B, C, M and Y, have predictable lifetimes before they require replacement and are operator replaceable components. In lieu of a photoconductive drum, which is preferred, a photoconductive belt can be used.

Each marking particle image formed on a respective PIFM is transferred electrostatically to an intermediate transfer module (ITM) 208B, C, M and Y, respectively. The ITM 208B, C, M and Y have an expected lifetime and are, therefore, considered to be operator replaceable components. In the preferred embodiment, each ITM 208B, C, M and Y, have an outer sleeve 243B, C, M and Y that contains the surface that the image is transferred to from PIFM 203B, C, M and Y. These outer sleeves 243B, C, M and Y are considered operator replaceable components with predictable lifetimes. The PIFMs 203B, C, M and Y are each caused to rotate about their respective axes by frictional engagement with their respective ITM 208B, C, M and Y. The arrows in the ITMs 208B, C, M and Y indicate the direction of their rotation. After transfer, the toner image is cleaned from the surface of the photoconductive drum by a suitable cleaning device 204B, C, M and Y, respectively to prepare the surface for reuse for forming subsequent toner images. Cleaning devices 204B, C, M and Y are considered operator replaceable components by the present invention.

Marking particle images are respectively formed on the surfaces 242B, C, M and Y for each of the outer sleeve 243B, C, M and Y for ITMs 208B, C, M and Y, and transferred to a toner image receiving surface of a receiver member, which is fed into a nip between the intermediate image transfer member drum and a transfer backing roller (TBR) 221B, C, M and Y, respectively. The TBRs 221B, C, M and Y have predictable lifetimes and are considered to be operator replaceable components by the invention. Each TBR 221B, C, M and Y, is suitably electrically biased by a constant current power supply 252 to induce the charged toner particle image to electrostatically transfer to a receiver sheet. Although a resistive blanket is preferred for TBR 221B, C, M and Y, the TBR 221B, C, M and Y can also be formed from a conductive roller made of aluminum or other metal. The receiver member is fed from a suitable receiver member supply (not shown) and is suitably “tacked” to the PTW 216 and moves serially into each of the nips 210B, C, M and Y where it receives the respective marking particle image in a suitable registered relationship to form a composite multicolor image. As is well known, the colored pigments can overlie one another to form areas of colors different from that of the pigments. The receiver member exits the last nip and is transported by a suitable transport mechanism (not shown) to a fuser where the marking particle image is fixed to the receiver member by application of heat and/or pressure and, preferably both. A detack charger 224 may be provided to deposit a neutralizing charge on the receiver member to facilitate separation of the receiver member from the belt 216. The detack charger 224 is another component that is considered to be operator replaceable within the invention. The receiver member with the fixed marking particle image is then transported to a remote location for operator retrieval. The respective ITMs 208B, C, M and Y are each cleaned by a respective cleaning device 211B, C, M and Y to prepare it for reuse. Cleaning devices 211B, C, M and Y are considered by the invention to be operator replaceable components having lifetimes that can be predicted.

Appropriate sensors (not shown) of any well known type, such as mechanical, electrical, or optical sensors for example, are utilized in the reproduction apparatus 200 to provide control signals for the apparatus. Such sensors are located along the receiver member travel path between the receiver member supply through the various nips to the fuser. Further sensors may be associated with the primary image forming member photoconductive drum, the intermediate image transfer member drum, the transfer backing member, and various image processing stations. As such, the sensors detect the location of a receiver member in its travel path, and the position of the primary image forming member photoconductive drum in relation to the image forming processing stations, and respectively produce appropriate signals indicative thereof. Such signals are fed as input information to a logic and control unit LCU which interfaces with a computational element. Based on such signals and a suitable program for the microprocessor, the control unit LCU produces signals to control the timing operation of the various electrostatographic process stations for carrying out the reproduction process and to control drive by motor M of the various drums and belts. The production of a program for a number of commercially available microprocessors, which are suitable for use with the invention, is a conventional skill well understood in the art. The particular details of any such program would, of course, depend on the architecture of the designated microprocessor.

The receiver members utilized with the reproduction apparatus 200 can vary substantially. For example, they can be thin or thick paper stock (coated or uncoated) or transparency stock. As the thickness and/or resistivity of the receiver member stock varies, the resulting change in impedance affects the electric field used in the nips 210B, C, M, Y to urge transfer of the marking particles to the receiver members. Moreover, a variation in relative humidity will vary the conductivity of a paper receiver member, which also affects the impedance and hence changes the transfer field. Such humidity variations can affect the expected lifetime of operator replaceable components.

In feeding a receiver member onto belt 216 charge may be provided on the receiver member by charger 226 to electrostatically attract the receiver member and “tack” it to the belt 216. A blade 227 associated with the charger 226 may be provided to press the receiver member onto the belt and remove any air entrained between the receiver member and the belt. The belt 216, the charger 226 and the blade 227 are considered operator replaceable components.

The endless paper transport web (PTW) 216 is entrained about a plurality of support members. For example, as shown in FIG. 2, the plurality of support members are rollers 213, 214 with preferably roller 213 being driven as shown by motor M to drive the PTW. Support structures 275a, b, c, d and e are provided before entrance and after exit locations of each transfer nip to engage the belt on the backside and alter the straight line path of the belt to provide for wrap of the belt about each respective ITM. This wrap allows for a reduced pre-nip ionization and for a post-nip ionization which is controlled by the post-nip wrap. The nip is where the pressure roller contacts the backside of the belt or where no pressure roller is used, where the electrical field is substantially applied. However, the image transfer region of the nip is a smaller region than the total wrap. Pressure applied by the transfer backing rollers (TBRs) 221B, C, M and Y is upon the backside of the belt 216 and forces the surface of the compliant ITM to conform to the contour of the receiver member during transfer. The TBRs 221B, C, M and Y may be replaced by corona chargers, biased blades or biased brushes, each of which would be considered by the invention to be operator replaceable components. Substantial pressure is provided in the transfer nip to realize the benefits of the compliant intermediate transfer member which are a conformation of the toned image to the receiver member and image content on both a microscopic and macroscopic scale. The pressure may be supplied solely by the transfer biasing mechanism or additional pressure applied by another member such as a roller, shoe, blade or brush, all of which are operator replaceable components as envisioned by the present invention.

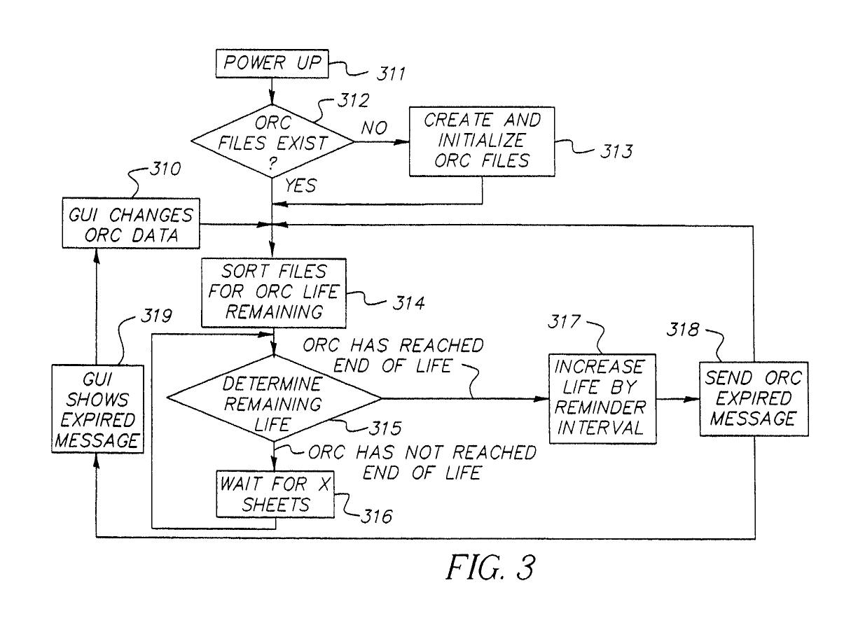

FIG. 3 is a flowchart that details the operations that are performed by the system of the present invention. ORC Tracking, generally referred to as 300, is initialized at Power Up 311 and then begins by executing ORC Files Found 312. ORC Files Found 312 looks at the object files for the ORC devices to check that all necessary object files are present. If any of the necessary object files are not found, then Create and Initialize ORC Files 313 is run to install these files.

The object files within the preferred embodiment are data structures called records. Each record used as an object file contains information related to a particular ORC device. Other types of data structure can also be used to retain the information related to specific ORC devices, however records are the type of data structure used by the preferred embodiment of the invention. Within the preferred embodiment, entries are made within each of the object files for life history of that particular type of ORC device, the predicted life for that specific ORC device that is currently installed and the amount of use on that ORC device that is currently installed. Additionally, each object file can contain a number of setpoints that can be accessed by various computational elements within system 102. The provisions of setpoints that can be accessed by the computational element to the GUI 106, the DFE or any other computational elements in the digital printing system 103 is a feature of the preferred embodiment and it will be readily understood that other architectural configurations can be substituted without departing from the spirit of the present invention. Another item within each of the object files for an ORC device is whether that ORC device is to be dormant. Dormancy as used herein refers to whether a parameter for an ORC device is to be used as a trigger point within the system 102 to alert the operator to a potential problem with that ORC device. The dormancy feature can be either enabled or disabled. The rationale for having a dormancy feature is that with certain types of ORC devices, it might be desirable for the operator to employ visual rather than automatic notification that lifetime of an ORC device has expired. A visual notification would typically be desirable when it is believed that system predictors do not provide sufficient accuracy and that physically looking at the printed output to notice any problems is the best manner by which to determine problems occurring from that ORC. If the dormancy feature for a specific ORC device is disabled, then the trigger mechanism is enabled for that ORC device and will be a potential trigger for an operator alert once the expected lifetime of that ORC device has expired. Another entry that is contained in the object file is for a reminder that is sent to the operator alerting the operator that an ORC device has failed, or will soon fail. As shown in FIG. 3, the Send Reminder Interval 317 alerts the operator when the expected lifetime for an ORC device has expired. The specifics for Send Reminder Interval 317 are acquired by accessing the object file for that ORC device in question. The Send Reminder Interval 317 is a message to alert the operator via the GUI 106 and is made by accessing the object file for that specific ORC device and reading entries in the object file. As envisioned by the preferred embodiment, the reminder interval is a parameter in the object file that is accessed to acquire the reminder period that is used to remind the operator that the specific ORC has an expired expected lifetime. This period can be a time period used to set a timer from which the operator can repetitively be alerted, or it can be measured in terms of use of that ORC device, which in the preferred embodiment would be a number of sheets printed. The time period can also be set in terms of times and dates to alert the operator per minute, per hour, per day or per week. Other information that is contained in the object file for an ORC is information detailing the quantity of that specific ORC device that has been used in the machine over the lifetime of the machine. Additionally, historical data for each one of the ORC devices for that specific ORC device is provided for increased capabilities in the database manager system. In this manner, a computational element can access the object file for a specific ORC device and acquire all the historical data for that ORC device and calculate an expected lifetime for that ORC based on the history of that ORC as it has been used in that digital printing device 103 for that particular user. Historical data can be used to compute expected lifetimes dynamically and provides for a high degree of personalization for a digital printing system. Personalization is important because of the numerous variables that can effect the lifetime of the ORC devices. These variables will be discussed below in more detail.

Still referring to FIG. 3, after the ORC Tracking 300 system verifies that the necessary ORC files exist, the system branches to Sort Files 314, which is a routine that looks at the ORC object files and sorts through them to determine which ORC device should be expected to expire first. The ORC devices within the preferred embodiment have their remaining life determined in terms of the number of remaining A4 pages that can be expected to be printed before failure and this is the type list shown in Table 1, however, it should be noted that Table 1 provides an example list and does not provide an exhaustive list of every ORC envisioned by the invention. While the preferred embodiment measures remaining life for ORC devices in terms of pages, it is also envisioned by the invention that remaining life can be measured in time, or by specific date depending on the types of use that a system encounters. The Sort Files 314 routine of the present invention will organize the list of ORC devices in terms of the expected remaining life. The ORC device with the shortest estimated life is listed first, the ORC with the second shortest expected life listed second, and so on until all the ORC devices have been listed in terms of their remaining expected life. In this manner, the preferred embodiment has the earliest expiration period listed first and only needs to look at the first element on the list to provide the operator with information related to the ORC that is expected to expire first. An exception to the foregoing discussion related to the list of ORC devices being where an ORC device has just been replaced or during the first power up of the machine where the Sort Files 314 again must process multiple ORC object files.

The preferred embodiment only requires that the system 102 check the object file for that ORC device that is on the top of the list as shown in Table 1 after the Sort Files 314 routine is run and verify that the most recent use of the digital printer 103 has not exceeded the remaining life of that ORC device with the shortest remaining life. The preferred embodiment only needs this single value checked because this is the ORC that is expected to expire first and results in less processing overhead that is placed on system 102. The Sort Files 314 routine sorts all the ORC devices and sends the list of ORC devices to the GUI 106, which allows the operator to view the life expectancies of the various ORC devices. It should be understood that variations of the above discussed sort routine will be readily apparent to those skilled in the relevant art. There are numerous sort routines known within the art that will provide the necessary functionality required by the present invention.

Determine Remaining Life 315 takes the remaining life values from the object file for each of the ORC devices and decrements the remaining life value for each of the ORC devices by the number of pages that have been printed since the last time Determine Remaining Life 315 has been run. A determination is made if any of the ORC devices lifetime has expired. In the preferred embodiment, a printed sheet would typically be an A4 page and a sheet that is 11 inches by 17 inches would result in decrementing the remaining life of the ORC device by two pages. Therefore, the remaining life values in the object files for each of the ORC devices are decremented by 1 for each A4 sheet that is printed and by 2 for each 11 inch by 17 inch sheet that is printed. Duplex pages would typically be counted twice as much as a single sided page in determining the remaining life of the ORC devices. The parameters used to determine the remaining life of the ORC devices can also be related to color. Sheets that require substantial amounts of color or large amounts of particular colors can have individual parameters indicative of the usage of large amounts of that color or colors.

If the result of Determine Remaining Life 315 indicates that an ORC has Reached the End of its Lifetime, then Send Reminder Interval 317 accesses the object file for that object file as previously discussed and sets up the interval with which the operator will be reminded that the expected life span for that ORC has expired. Once Determine Remaining Life 315 makes a determination that one of the ORC devices has reached its expected lifetime, the preferred embodiment has Send ORC Expired Message 318 to provide the operator with a notification of the fact that an ORC has expired by alerting the operator via GUI 106. It will be readily understood to those skilled in the art, that there are numerous means for notification. The alert can be by any alarm mechanism. The alert can also be via a user interface that is not a graphical user interface.

If Determine Remaining Life 315 indicates that none of the ORC devices have reached their expected lifetime, Wait for Time Period 316 provides a function that will allow a predetermined parameter to expire before branching back to Determining Remaining Life 315. In the preferred embodiment Wait for Time Period 316 will provide a timer that is set to wait a predetermined period of time before branching back to Determine Remaining Life 315. The time period set by Wait for Time Period 316 in the preferred embodiment is set to match the remaining life of the ORC device with the lowest expected lifetime. Other parameters can be used instead of time periods to determine the actual period of Wait for Time Period 316, and the use of other parameters is specifically envisioned by the present invention. Among these different parameters are time periods other than the remaining life of an ORC device, such as a specific number of sheets that have been printed (or possibly every sheet) instead of, or in combination with time periods related to the remaining life of an ORC. Additionally, specific time periods can be used to establish the time period used by Wait for Time Period 316.

After the parameter used by Wait for Time Period 316 has expired, Determine Remaining Life 315 will again access the remaining life values from the object files for the ORC devices and decrement the remaining life value for each of the ORC devices by the number of pages that have been printed since the last time Determine Remaining Life 315 has been run, as previously stated.

The NexPress®2100 uses the concept of Operator Replaceable Component (ORC) devices to reduce overall per page print cost and maximize print quality and uptime at the customer site. The ORC devices within the preferred embodiment of the present invention, are components within the printer that are designed to be replaced by the printer operator without requiring the services of a more highly skilled field engineer. In order for ORC devices to achieve the goal of reducing per page print costs, it is necessary to know when the “optimal” life of an ORC device has been reached. Here “optimal” is used to describe the point after which further printer use with the ORC device that has reached its' optimal life will potentially either adversely affect print quality or fail. It is important in any printing system to understand the variables that result in print quality. It is extremely important in systems involving high-end digital printers, that the variables affecting print quality are well known. Additionally, the operators for these printing systems need to be aware of the state of the variables that can affect print quality. The present invention addresses these needs by providing a realtime update of the expected life span for ORC devices upon demand as well as notification of a situation where the expected lifespan of an ORC device is about to expire, or in fact already has expired. The specific timing of this notification also needs to be as accurate as possible, especially in high-end digital printing systems, because of the high volume of prints that are made to insure maximum component life is not exceeded, which in turn results in minimizing the per page print cost for that printer and maximizing print quality.

Actual life of a specific ORC in a specific printer is dependent on many factors. Among these factors are the number of pages printed, the size of the pages, printing on one side (simplex) versus both sides (duplex) of the paper, the type of finish, the characteristics of the paper, the environment in which the printer resides (room temperature, air quality, dust contaminants), the number of times the printer is shut down and restarted, and the manufacturing quality of the ORC. While it is not practical for the system to immediately characterize all of the variables that affect the life of an ORC device, it is possible to provide systems that can characterize these variables that have a determining factor in the life of a specific ORC. The present invention envisions predicting the lifetimes of ORC devices accurately by taking into account the past history of the same or similar ORC devices.

To achieve the goal of predicting the life of an ORC device as accurately as possible, the present invention envisions ORC tracking system software that can perform these important tasks. Once a specific ORC device has expired, a replacement for that specific ORC device is placed into the system. The system software then takes the life information for the expired ORC device and places it into a history list file for that ORC device. In the preferred embodiment this history file would be retained in the object file as previously discussed. When that specific ORC device is replaced again, the additional history information is added to this list so that life history for each specific ORC device can be retrieved and used for calculation. After an ORC device is replaced, the system software calculates a new life expectancy based on the life spans of the previous ORC devices. The new life expectancy then becomes the expected life span for the ORC device.

For an unweighted average of N histories for a specific ORC, this would be calculated using the formulas shown in Equations 1a and 1b to arrive at the total history and the new life calculations, which are a generalization of unweighted Average Calculation for N ORCs.

Total_History=history_{N}+history_{N-1}+history_{N-2}+history_{N-3} . . . history₁ Equation 1a

new_life=Total_History/N Equation 1b

In the preferred embodiment, the ORC device tracking system typically employs default values for life expectancy of the ORC devices. The historical data derived from previously used ORC devices is employed, by the preferred embodiment, after there have been sufficient numbers of ORC devices of a specific type replaced. The object files for each of the ORC devices keeps a record of the number of times a specific ORC device has been replaced, as well as the average life of an ORC device. Using a replacement history for a specific ORC device that equals 10 replacements, Equations 2a and 2b illustrate the total history and the new life calculations.

Calculation of unweighted Average of 10 ORCs

Total_History=history₁₀+history₉+history₈+history₇+history₆+history₅+history₄+history₃+history₂+history₁ Equation 2a

new_life=Total_History/10 Equation 2b

A number of variations for calculating the predicted life have been used, including weighted averages and averages that take into account fewer replacement histories. The present invention envisions using historical data to predict component replacement by employing a relatively simple mathematical formula.

By calculating a new life based on replacement history, the system software can adapt to changes in variables that effect print quality such as printer usage and printer environment. The system software can then reflect the impact of these variable changes in the predicted life of the ORCs. Once in place with the ability to adapt the predicted life of the ORCs to variable changes, the system software can personalize the predicted ORC life on a per printer basis dynamically as ORCs are replaced and account for all the factors that influence an ORCs life by using historical ORC life data. By accounting for the variable influences on ORC life, the system achieves the goal of optimizing predicted ORC component life on a per printer basis, minimizing per page print costs while maximizing print quality.

A further embodiment of the present invention patent is to use a weighted average incorporating a predefined “default life” for initial part replacement until a suitable number of replacements histories have been made to provide an “interim” accurate average. As an example, take 10 histories as a sample of the preferred number of histories to use to determine future life, if there is less than 10 histories, a weighted average based on the number of histories available (up to 10) divided by 10 (which gives us a number between 0.0 and 1.0, where we get 1.0 if we have at least 10 histories and we get 0.0 if we have no replacement histories) multiplied by the average of the histories and the inverse of this number multiplied by the “default life” and the two numbers then added together to give us a predicted life. The Calculation of weighted Average of less than 10 ORCs and a “Default Life” is shown by Equations 3a, 3b and 3c.

Ratio=Total History (up to 10) divided by 10.0 Equation 3a

InverseRatio=1.0−Ratio Equation 3b

Predicted_Life=new_life (from Equation 2)*Ratio+default_life*InverseRatio Equation 3c

It should also be noted, that the Predicted Life can be determined without using any default value. One such manner of doing this would be to allow the first ORC device to expire, and then use the life of that first ORC device as the replacement history. Once the replacement history is initiated, the operator could use the replacement history as the expected life of the ORC device. The replacement history could then be updated as future ORC devices are used. It should be readily understood that there are numerous weighted averages that can be employed to determine a predicted life of an ORC device.

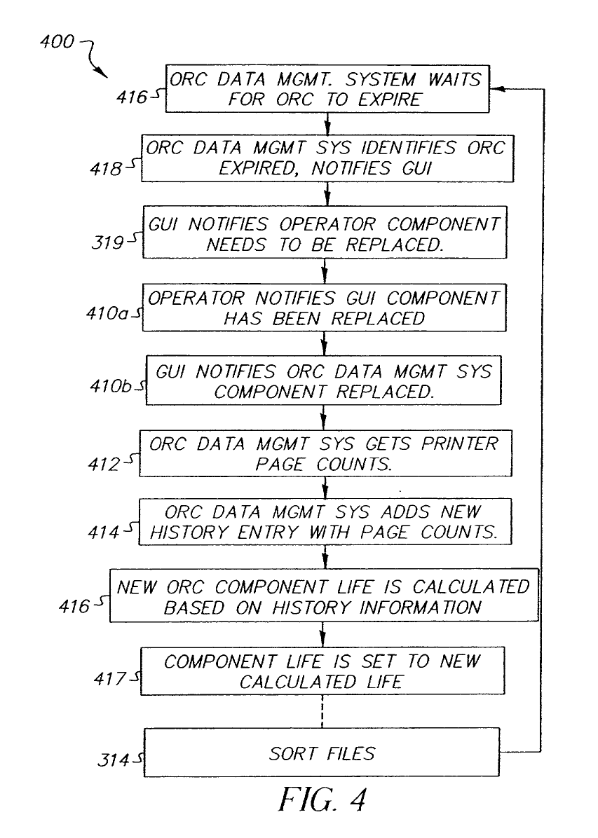

FIG. 4 is a flowchart showing the operation of the present invention employing the ORC Tracking previously described used in combination with history data used to predict life span for the ORCs. Generally referred to as 400, the series of events for determining the predicted life span using ORC history data is a combination of what has previously been discussed for the flowchart shown in FIG. 3 together with the portion that employs ORC data to generate ORC device life expectancy. The series of events from FIG. 3 are present in FIG. 4 in a more high level form for the sake of brevity. Wait for ORC to Expire 416 is essentially equivalent to the series of steps from the flowchart in FIG. 3 Determine Remaining Life 315 and Wait for Time Period 316. Once an ORC expires (as previously discussed) the system will then perform Identify the ORC Expired and Notify GUI 418, which is similar to the combination of Send ORC Reminder Interval 317 and Expired Message 318 of FIG. 3. Identify the ORC Expired and Notify GUI 418 will alert the print operator that the expected lifetime of an ORC has expired and that the ORC needs to be replaced. Notify GUI of ORC Replacement 410a is where the operator inputs to the user interface (the GUI 106) that the expired ORC has been replaced and GUI Notifies ORC Data management of ORC Replacement 410b informs the ORC database manager that a new ORC has been installed in place of the ORC that has expired. Update ORC Data Management System With Printer Page Counts 412 updates the ORC database manager with any page counts from recent use of the digital printer 103 that have not yet been accounted for by the system 102. ORC Data Management System Adds New History Data With Page Count Updates 414 takes the page counts from Update ORC Data Management System With Printer Page Counts 412 and updates the ORC database manager. New ORC Component Life is Calculated 416 takes the updated ORC database manager information and computes a new life expectancy for the ORC that has just been replaced using the equations that have previously been discussed. Component Life is Set 417 takes the computed life and applies it to the ORC that has just been replaced. The system of the preferred embodiment then braches back Waits for ORC to Expire 416 because the preferred embodiment of the present invention has different computational elements performing the flowcharts shown in FIG. 3 and FIG. 4. The flowchart in FIG. 4 is performed by the computational elements in the NextStation™ and the Sort Files 314 routine of FIG. 3 is performed by the DFE in the digital printer 103.

In systems having only one computational element, or using only one computational element to perform both the flow charts shown in FIG. 3 and FIG. 4, then Sort Files 314 would be run after Components Life is Set 417 as shown by the dotted line in FIG. 4. Here, the object files for the ORC devices would again be looked at to determine which ORC has the shortest life expectancy. As previously detailed in the discussion related to FIG. 3, there are numerous ways that the ORC object files can be sorted, and also numerous ways by which time periods can be set. It will be readily apparent to those skilled in the art, that there are alternatives to using the ORC with the shortest life as the basic parameter by which to operate from. Numerous thresholds can be applied. Multiple thresholds can operate simultaneously for different ORC devices to alert the operator when life expectancies are running short.

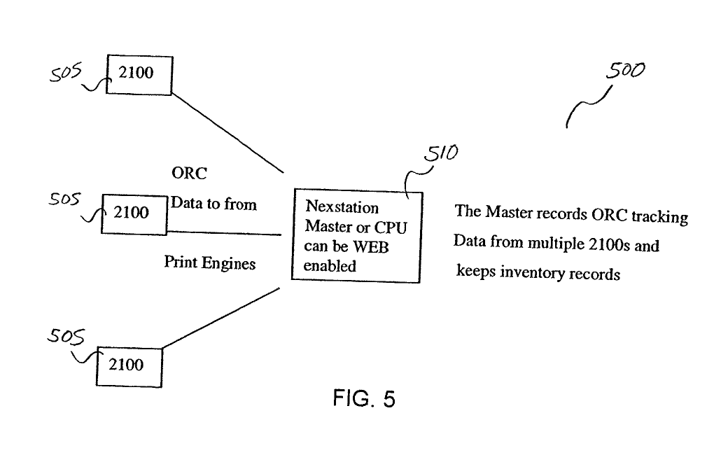

The inventory management system 500 of the invention details and records expected remaining life information for Operator Replaceable Components by recording the use, and the types of use, for the Operator Replaceable Components. The preferred embodiment of the present invention, as seen in FIG. 5, employs printing devices 505 that contain tracking features for serviceable components and consumables within the printing devices 505. The printing devices 505 relate tracking information to an inventory system master 510. The inventory system master 510 is responsible for managing the inventory of replaceable components and consumables for the printing device 505. The preferred embodiment of the invention employs as printing devices 505 at least one NexPress®2100 having an online Operator Replaceable Component (ORC) device life tracking system that is used in conjunction with the inventory management system 500, generally referred to as 500. The ORC life tracking system within the NexPress®2100 enables an operator to manage the inventory of the ORC devices and, furthermore, enables replacement of the ORC devices within a time frame that optimizes machine performance as well as the uptime of the machine. The inventory management system 500 can also be configured so that the ORC life tracking system for each of several NexPress®2100 machines can have a single inventory management system 500 that operates on a single machine, generally referred to herein as the master 510, and allows the operator of the master 510 to manage the inventory of ORC devices for several NexPress®2100 machines with a single inventory. The preferred embodiment of the invention provides for the automated decrementing of a specific ORC device within the inventory upon usage of that specific ORC device.

Still referring again to FIG. 5, the present invention envisions two basic models of tracking inventory for ORC devices. The first model uses the capabilities of the user interface (GUI 106) for each of the NexPress®2100 printing devices 505 to provide for the inventory tracking. In this first model, the ORC devices are placed into NexPress®2100 printing devices 505 by the printer operator, the printer operator then identifies the replacement of that ORC device to the inventory management system 500 by making an entry using the GUI 106 to that printing device 505. The interface between the print devices 505 and the master 510 of the inventory management system 500 receives the entry that was made locally at the printing device 505 and enters the consumption data to the inventory database. The master 510 takes local entries from the printing device 505 and places it into the inventory, which is globally maintained for all pieces of equipment in the inventory management system 500. The globally maintained inventory then removes the replaced ORC device from the inventory. Locally, the NexPress®2100 printing device 505 will allow the printer operator to view information relating to the remaining life, replacement history and average expected life of the ORC devices after an ORC device has been replaced as previously discussed. Additionally, the interface between the master 510 and the NexPress®2100 printing device 505 will allow the printer operator to view information relating to the entire inventory. Globally, the inventory management system 500 tracks inventory consumption directly through the communication interface between the master 510 to inventory management system 500 and all NexPress®2100 printing devices 505 sharing the inventory.

In the second model, the inventory master 510 controls the updating of the inventory directly from the master 510. The second model would be preferable where, for example, a vault is used to store the inventory for the ORC devices. Each time an ORC device within a NexPress®2100 printing device 505 is to be replaced, the replacement part would have to be retrieved from the inventory, which is stored in the vault. The inventory master 510 would typically have a location that is associated with the vault, or even located at the vault. In the second model, the operator of the inventory master 510 would be responsible for the management of the inventory and the printer operator for the printing device 505 would only respond to messages that are generated locally from the NexPress®2100 printing device 505 to replace any given ORC device. Therefore, the operator of the inventory master 510 would be responsible for entering data relative to the inventory and there is no need for inventory usage to be entered separately by the operator of the NexPress®2100 that is actually receiving the ORC device that is being removed from inventory.

It is envisioned by the invention that the inventory management system 500 either provide a flag within the system software, or a mechanical switch to identify whether the first or second model is being employed to manage the inventory. In both models, the printer operator can view inventory information from the master 510. Also, in both models the inventory management system 500 receives ORC tracking information from all the NexPress®2100 printing devices 505 sharing the same inventory.

As previously discussed, the ORC tracking system for each NexPress®2100 will determine the correct time to replace an ORC device, and notify the operator by presentation of an alert box within the GUI 106 requesting them to perform the task. The operator will also acknowledge the completion of the task via the GUI 106. The replacement information regarding the ORC device, including the ORC ID (which is typically the inventory catalog number), the quantity replaced, the previous actual replacement life and new predicted average life is transferred to the inventory management system 500. The inventory management system 500 for one, or more,NexPress®2100 printing devices 505 can calculate expected lifetimes for ORC devices in terms of a single NexPress®2100 printing device 505 and it's associated use patterns, or in terms of multiple NexPress®2100 printing devices 505 and their use patterns associated with the entire group of NexPress®2100 printing device 505. Alternatively, the group of NexPress®2100 printing devices 505 can have use patterns arranged into groups of NexPress®2100 printing device 505 or be broken into use patterns for individual NexPress®2100 printing devices 505.

Preferably, the NexPress®2100 printing device 505 will transfer daily printer page counts to the inventory management system 500. The inventory management system 500 can then predict that inventory needs in accordance with the current use of the NexPress®2100 printing device 505 or predict inventory needs based on a number of parameters related to the use of the NexPress®2100 printing device 505.

Information regarding the stock within the inventory for each ORC devices is retained by the inventory management system 500 and this inventory data can be transferred to the GUI 106 of a NexPress®2100 printing device 505 to allow the operator to view the available stock before performing a replacement. This transfer of inventory data can take place from the inventory master 510 to any slave NexPress®2100 printing device 505 that shares the inventory.

The inventory management system 500 within the preferred embodiment is accessible by the operator for any NexPress®2100 printing device 505 that shares the inventory simply by using the GUI 106 to the printing device 505. Communication between the application and an external server(s) provide the transactional data needed to process orders. Critical thresholds relative to the remaining life of the ORC devices can be customized for the inventory management of multiple machines. These thresholds can be used by the inventory database to trigger the automatic creation of an ORC device order sheet accompanied by an operator notification that it is time to replace an ORC device that has already been in use for its' expected life. The system of the preferred embodiment provides a GUI 106 that allows the printer operator, or some other person in the print shop such as the operator of the inventory master 510, to set reorder levels, generate recommendation reports, pull inventory, receive inventory, examine inventory, order inventory, reorder inventory, log activities, configure inventory, and modify inventory for ORC devices. The inventory management system 500 of the invention thus enables a print ship to manage inventory by placing orders, creating ordering forms, writing reports related to machine usage and generally, maintain the inventory. Table 2 below illustrates a typical ORC inventory listing, as it would be displayed on a GUI 106 for a NexPress®2100 printing device 505.

TABLE 2

| ORC | | | | Suggested | ORC |
|---|---|---|---|---|---|
| Catalog | | Average | Quantity | Quantity | Reorder |
| Number | ORC Description | Life | on Hand | On Hand. | Point. |
| 21001 | NexPress DryInk, Cyan | 25,000 | 0 | 8 | 2 |
| 21002 | NexPress DryInk, Magenta | 25,000 | 0 | 8 | 2 |
| 21003 | NexPress DryInk, Yellow | 25,000 | 0 | 8 | 2 |
| 21004 | NexPress DryInk, Black | 12,500 | 0 | 16 | 4 |
| 21017 | Developer, Cyan | 300,000 | 0 | 200 | 40 |
| 21018 | Developer, Magenta | 300,000 | 0 | 200 | 40 |
| 21019 | Developer, Yellow | 300,000 | 0 | 200 | 40 |
| 21020 | Developer, Black | 300,000 | 0 | 200 | 40 |
| | General Press Maintenance | 50,000 | 0 | 2 | 1 |
| 21025 | Fuser Roller Ay | 150,000 | 0 | 5 | 1 |
| 21026 | Contact Skive Finger | 45,000 | 0 | 2 | 1 |
| 21027 | Pressure Roller | 200,000 | 0 | 2 | 1 |
| 21029 | Donor Roller | 375,000 | 0 | 2 | 1 |
| 21030 | Fuser Fluid | 100,000 | 0 | 2 | 1 |
| 21031 | Fuser Cleaning Web | 100,000 | 0 | 200 | 40 |
| 21032 | Transport Web | 100,000 | 0 | 2 | 1 |
| 21033 | Imaging Cylinder Cleaner | 4,000,000 | 0 | 2 | 1 |
| 21034 | BC Cleaning Ay | 4,000,000 | 0 | 2 | 1 |
| 21035 | IC/BC Cleaning Brush | 2,200,000 | 0 | 2 | 1 |
| 21036 | IC/BC Cleaning Blade | 200,000 | 0 | 8 | 2 |
| 21037 | Cleaner Sump | 550,000 | 0 | 2 | 1 |
| 21038 | Cleaning Web | 550,000 | 0 | 2 | 1 |
| 21039 | Imaging Cylinder | 230,000 | 0 | 2 | 1 |
| 21040 | Blanket Cylinder | 330,000 | 0 | 2 | 1 |
| 21041 | Primary/PreClean Wire | 200,000 | 0 | 2 | 1 |
| 21042 | Conditioner/Tackdown Wire | 200,000 | 0 | 11 | 3 |
| 21043 | PreClean Charger | 2,000,000 | 0 | 2 | 1 |
| 21044 | Narrow Primary Grid | 7,000,000 | 0 | 2 | 1 |
| 21045 | Wide Primary Grid | 3,000,000 | 0 | 2 | 1 |
| 21046 | Primary Charger | 2,000,000 | 0 | 2 | 1 |
| 21047 | Conditioning Charger Grid | 1,000,000 | 0 | 2 | 1 |
| 21048 | Tackdown Charger | 2,000,000 | 0 | 2 | 1 |
| 21049 | Conditioning Charger | 14000,000 | 0 | 2 | 1 |
| 21050 | PreClean Grid | 2,000,000 | 0 | 2 | 1 |
| 21051 | DryInk Collection Bottle | 135,000 | 0 | 2 | 1 |
| 21054 | Pressure Roller Cleaner | 40,000 | 0 | 2 | 1 |
| | Sheet | | | | |
| 21055 | 50 Hz Fuser Lamp | 2,000,000 | 0 | 2 | 1 |
| 21056 | 60 Hz Fuser Lamp | 2,000,000 | 0 | 2 | 1 |
| 21057 | Pressure Roller Lamp | 2,000,000 | 0 | 2 | 1 |
| 21058 | Wiper Pads | 200,000 | 0 | 4 | 1 |
| 21059 | Fuser Pads | 475,000 | 0 | 2 | 1 |
| 21060 | Metering Blade | 475,000 | 0 | 2 | 1 |
| 21061 | Metering Roller | 875,000 | 0 | 2 | 1 |
| 21062 | FuserSump | 130,000 | 0 | 2 | 1 |
| 21063 | Cleaner Sump | 125,000 | 0 | 2 | 1 |
| | Perfector Belt Maintenance | 200,000 | 0 | 2 1 | |
| 21064 | Water Filter Cartridge | 500,000 | 0 | 2 | 1 |
| 21074 | BC Charger | 1,800,000 | 0 | 2 | 1 |

In Table 2, the ORC devices are listed in terms of increasing Catalog Numbers. This is a different ordering from Table 1 where the ORC devices were listed in terms of decreasing remaining life. Table 2 includes, for each of the ORC devices, columns for: catalog number, description, average life, quantity on hand, suggested quantity and an ORC reorder point. The columns for catalog number, description and average life for the ORC devices are the same as those in Table 1, with different ordering. The column quantity on hand provides the number of each of the ORC devices contained in inventory as the present time. The column suggested quantity gives an amount of replacement ORC devices that is suggested by the inventory management system 500 as being contained in the inventory for each of the ORC devices listed in Table 2. The column for ORC reorder point gives the threshold quantity for each of the listed ORC devices that, once reached, indicates that ORC device needs to be reordered to replenish the supply in inventory.

The ORC inventory management system 500 will notify the inventory manager in the event the inventory threshold for a tracked ORC device has been reached. It should be understood that the inventory threshold is a different trigger mechanism than the previously discussed trigger mechanism that is activated when an ORC device reaches its' expected lifetime. The inventory threshold relates to the number of ORC devices within the inventory compared to a desired amount that the inventory tracking system compares to the actual number of ORC devices within the inventory. The actual number of any ORC device contained within the inventory is incremented or decremented when the operator removes a stock item or replenishes a stock item, respectively. The operator can have the inventory management system 500 generate an ORC Recommendation Report that provides a suggested restocking list for ORC devices contained within the system. Table 3 below is an example of an ORC Recommendation Report.

TABLE 3

| | | | | Suggested | ORC |
|---|---|---|---|---|---|
| Catalog | | Quantity | Reorder | Quantity | Reorder |
| Number | Description | on Hand | Quantity | On Hand. | Point. |
| 21001 | NexPress DryInk, Cyan | 0 | 8 | 8 | 2 |
| 21002 | NexPress DryInk, Magenta | 0 | 8 | 8 | 2 |
| 21003 | NexPress DryInk, Yellow | 0 | 8 | 8 | 2 |
| 21004 | NexPress DryInk, Black | 0 | 16 | 16 | 4 |
| 21017 | Developer, Cyan | 0 | 200 | 200 | 40 |
| 21018 | Developer, Magenta | 0 | 200 | 200 | 40 |
| 21019 | Developer, Yellow | 0 | 200 | 200 | 40 |
| 21020 | Developer, Black | 0 | 200 | 200 | 40 |
| | General Press Maintenance | 0 | 2 | 2 | 1 |
| 21025 | Fuser Roller Ay | 0 | 5 | 5 | 1 |
| 21026 | Contact Skive Finger | 0 | 2 | 2 | 1 |
| 21027 | Pressure Roller | 0 | 2 | 2 | 1 |
| 21029 | Donor Roller | 0 | 2 | 2 | 1 |
| 21030 | Fuser Fluid | 0 | 2 | 2 | 1 |
| 21031 | Fuser Cleaning Web | 0 | 200 | 200 | 40 |
| 21032 | Transport Web | 0 | 2 | 2 | 1 |
| 21033 | Imaging Cylinder Cleaner | 0 | 2 | 2 | 1 |
| 21034 | BC Cleaning Ay | 0 | 2 | 2 | 1 |
| 21035 | IC/BC Cleaning Brush | 0 | 2 | 2 | 1 |
| 21036 | IC/BC Cleaning Blade | 0 | 8 | 8 | 2 |
| 21037 | Cleaner Sump | 0 | 2 | 2 | 1 |
| 21038 | Cleaning Web | 0 | 2 | 2 | 1 |
| 21039 | Imaging Cylinder | 0 | 2 | 2 | 1 |
| 21040 | Blanket Cylinder | 0 | 2 | 2 | 1 |
| 21041 | Primary/PreClean Wire | 0 | 2 | 2 | 1 |
| 21042 | Conditioner/Tackdown Wire | 0 | 11 | 11 | 3 |
| 21043 | PreClean Charger | 0 | 2 | 2 | 1 |
| 21044 | Narrow Primary Grid | 0 | 2 | 2 | 1 |
| 21045 | Wide Primary Grid | 0 | 2 | 2 | 1 |
| 21046 | Primary Charger | 0 | 2 | 2 | 1 |
| 21047 | Conditioning Charger Grid | 0 | 2 | 2 | 1 |
| 21048 | Tackdown Charger | 0 | 2 | 2 | 1 |
| 21049 | Conditioning Charger | 0 | 2 | 2 | 1 |
| 21050 | PreClean Grid | 0 | 2 | 2 | 1 |
| 21051 | DryInk Collection Bottle | 0 | 2 | 2 | 1 |
| 21054 | Pressure Roller Cleaner | 0 | 2 | 2 | 1 |
| | Sheet | | | | |
| 21055 | 50 Hz Fuser Lamp | 0 | 2 | 2 | 1 |
| 21056 | 60 Hz Fuser Lamp | 0 | 2 | 2 | 1 |
| 21057 | Pressure Roller Lamp | 0 | 2 | 2 | 1 |
| 21058 | Wiper Pads | 0 | 4 | 4 | 1 |
| 21059 | Fuser Pads | 0 | 2 | 2 | 1 |
| 21060 | Metering Blade | 0 | 2 | 2 | 1 |
| 21061 | Metering Roller | 0 | 2 | 2 | 1 |
| 21062 | Fuser Sump | 0 | 2 | 2 | 1 |
| 21063 | Cleaner Sump | 0 | 2 | 2 | 1 |
| | Perfector Belt Maintenance | 0 | 2 | 2 | 1 |
| 21064 | Water Filter Cartridge | 0 | 2 | 2 | 1 |
| 21074 | BC Charger | 0 | 2 | 2 | 1 |

The invention enables the automatic creation of forms to replenish inventory. The inventory management system 500 of the invention can create an order form for the ORC devices, automatically, by tracking the remaining life of each of the ORC devices in all the printers sharing a single inventory. It is envisioned that the automatic order form can be sent to a channel supplier of the desired consumables as a matter of normal business practice, or that the automatically generated order form can be reviewed by a person responsible for the management of the inventory prior being sent to a supplier. It is further envisioned by the invention, that the order form can be generated at periodic intervals, such as an option of providing an ordering frequency configured for a specific number of shipments per month. The preferred embodiment of an inventory management system 500 informs the operator of the master 510 if an unacceptable ordering frequency has been entered (alternatively, the inventory management system 500 can show only acceptable ordering options). Typically, an ordering frequency could be set too low (too seldom) or too high (too often) based on the printer usage rate, number of printers, and the business rules. Accordingly, the inventory management system 500 can be preset to not accept an ordering frequency that is not within an acceptable range as determined by the usage of the system.

The operator responsible for managing the inventory can define specific usage pattern business rules that are appropriate for their printing use. These usage patterns would typically be based on business rules that are provided to more accurately manage the inventory and the generation of orders for parts for the inventory. An example of a business rule specific to a single site, or printer, would be critical large high volume jobs are all preformed during the first two weeks of the month. This information would ensure that bimonthly shipments compensate for the uneven usage pattern and ensure adequate inventory will be available during peak demand times.

The invention also provides the capability to maintain the inventory for potentially numerous machines by enabling the operator to track devices that have expected lifetimes that can be predicted in terms of usage of the various machines. Thresholds are employed by the invention to enable the operator charged with the responsibility of inventory management to track the ORC devices in accordance with their relative usage. The thresholds can change in accordance with consumption level. There can also be multiple thresholds related to a single, or similar, ORC device parameter. Thresholds are established for ORC device expected lifetime until replenishment is required, as previously discussed. The invention's concept of inventory management employs the expected lifetime of the ORC devices in conjunction with the estimated usage of the ORC devices to predict inventory needs. Preferably, thresholds are provided at a critical level as well as a recommended level for replacement of ORC devices.

The interface between the inventory system master 510 and ORC devices can be accomplished by various mechanisms including but not limited to internet email, intranet based communication, real time communications between the NexPress®2100 and the inventory management system 500, or non-real time communications between the NexPress®2100 and the inventory management system 500.

The parameters employed by the inventory management system 500 of the invention can relate to items such as: life of ORC devices; time to restock; estimated future print volume computed by press allows operator adjustment; and preference for the types for which the printers are being employed. It will be readily appreciated that these parameters can be tailored to be values that are averages, maximized best case, or minimized worst-case representations of the parameters that are being employed by the system. The system can be tailored in a distributing processing manner, to have two or more computational elements within the individual printer devices 505 adjust the parameters in accordance with their particular use and report to the inventory management system 500, or the inventory management system 500 can adjust the parameters that are applied to all printers attached to the inventory management system 500.

The life tracking system for the ORC devices contained on the NexPress®2100 enables the operator with the knowledge of the optimum time to replace the ORC devices and allows the operator to manage the ORC devices in order to maximize the performance and the uptime of the machine. The inventory management system 500 of the preferred embodiment of the invention works in conjunction with the NexPress®2100 to provide on sight capability of inventory management by having the ability to view the stock currently within the inventory stock and to predict future inventory stock requirements.

The inventory management system 500 of the invention is linked to the life tracking system for the ORC devices. This linkage provides a mechanism that operates to decrement entries within the inventory for a specific ORC device once data is received by the inventory management system 500 that the specific ORC device has been replaced. There is an additional interrelationship that exists between the ORC device life tracking system and the inventory management system 500, in that the master 510 for the inventory management system 500 can predict future inventory needs from the information that it receives from the life tracking system. The inventory management system 500 can receive information related to ORC devices from either one or many NexPress®2100 machines by interfacing with the ORC device life tracking system for each of the NexPress®2100 machines.

The inventory management system 500 of the invention uses business rules to determine inventory needs, the quantities of consumables that need to be reordered and acceptable reordering frequency in accordance with system usage. The business rules employed by the preferred embodiment use the concept of consumable life of the components as determined by system usage. It will be readily appreciated that other types of business rules could be used within an inventory management system 500 such as time rather than system usage. The NexPress®2100 could employ an inventory management system 500 that predicts inventory requirements based on recent usage and automatically orders inventory within specific time periods. The inventory management system 500 of the preferred embodiment determines inventory needs based on a remaining “Page Life” of the ORC devices in relation to system usage in order to project the quantity of each of the ORC devices that needed to be reordered. The remaining life of the ORC devices provides additional parameters to traditional system usage concepts that are not available with prior art inventory systems that specify only units or time as the principle projection criteria.

The inventory “Page Life” is a dynamic variable that can change with different types of use or with different conditions of use. Therefore, over time, the “Page Life” of any specific ORC device can change in accordance with past usage and actual life of that specific ORC device. These changes can pertain to a specific printer site, or to an ORC device that has had data related to the expected life data changed from previous versions of that specific ORC device.

Each time an ORC type inventory item is taken out of stock and replaced in a machine, a new “Page Life” for that ORC device is computed. This new “Page Life” can be based on variables related to a specific printer, a specific printing site having numerous printers, past experienced life for that actual ORC device or various combinations of these parameters. Other parameters will be readily apparent to those skilled in the art. The inventory management system 500 can employ daily printer page counts in it's business rules to more accurately predict projected future usage of ORC devices and consumables in general to appropriately fill the inventory needs.

The parameter of a daily printer page count affects usage across all ORC devices. Inventory management systems that use consumption over a period of time as the parameter by which consumables or replaceable components need to be replaced provide no mechanism to effectively speed up or slow down time based predictions. Furthermore, systems having sensor based alarm mechanisms are not useful for the numerous types of ORC devices that are tracked by the present invention. The daily page counts that are applied by the invention can effectively speed up or slow down the predicted consumption of all ORC devices. Time based consumption does not readily allow modification according to use. The daily printer page counts employed by the invention can be from multiple printers at one site as well as a single individual printer. It will be readily apparent that other time periods can be used in place of daily page counts, such as weekly page counts or virtually any time period that appears suitable to the user of the inventory management system 500 of the invention.

The user interface (which in the preferred embodiment is GUI 106) allows entry into the inventory management system 500 to signify that a replacement of a serviceable part has been accomplished to replenish the inventory. The inventory management system 500 of the invention could also have the system updated by numerous other methods. One such method would be to provide a bar code on each of the serviceable components and an apparatus that would scan a bar code. The bar code would be entered into the system and allow for tracking of the component throughout it's lifetime. Other forms of detectable indicia are also envisioned by the invention. The potential range of detectable indicia can vary from human readable indicators to indicia that can only be read by a machine. Various types of machine-readable indicia could include indicia that can be optically scanned, or indicia that can be magnetically read by the system to log inventory of the serviceable components. Numerous other types of human and machine readable indicia will be readily apparent to those skilled in the art such as combinations of letters and numbers.

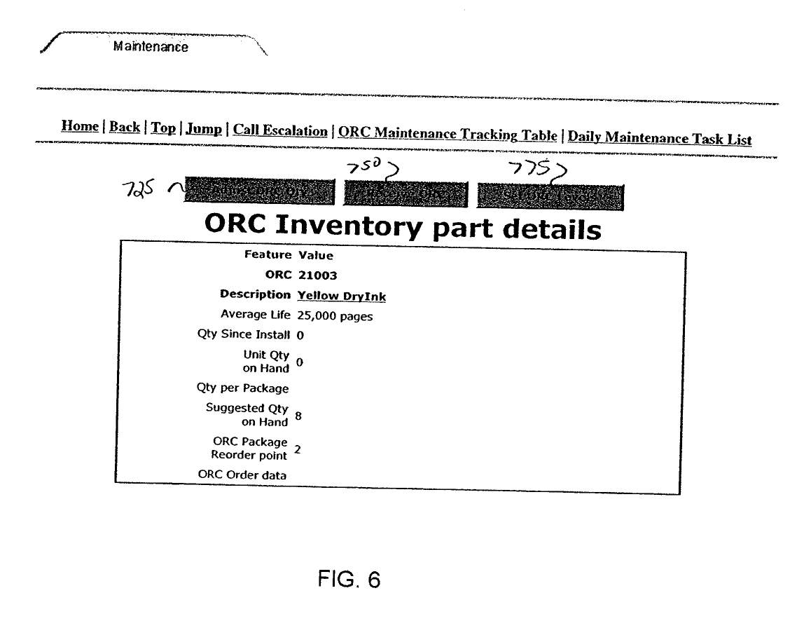

FIG. 6 is an illustration of the screen that is presented on the GUI 106 for replacement part details of a specific ORC within inventory. The ORC Inventory Part Details 600 screen shown in FIG. 6 is displayed once the operator for the NexPress®2100 printing device 505, or the inventory master 510, selects this function from the GUI 106. The ORC Inventory Part Details 600 screen shows similar information to that shown in Table 2 for the same catalog (ORC) number. There are three buttons, Adjust ORC Qty 725, Receive ORC 750, and Set ORC Levels 775, at the top of the ORC Inventory Part Details 600 screen that can be clicked on by the operator to allow one of several actions to be taken in relation to the management of inventory for this part.

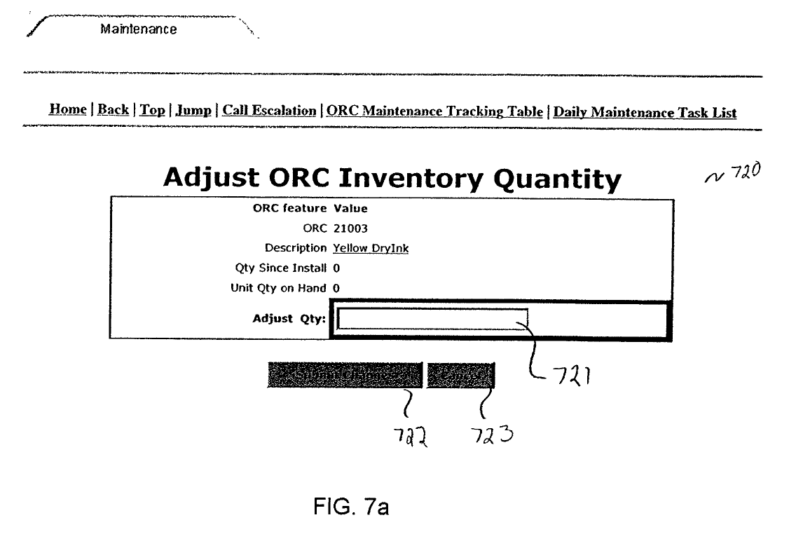

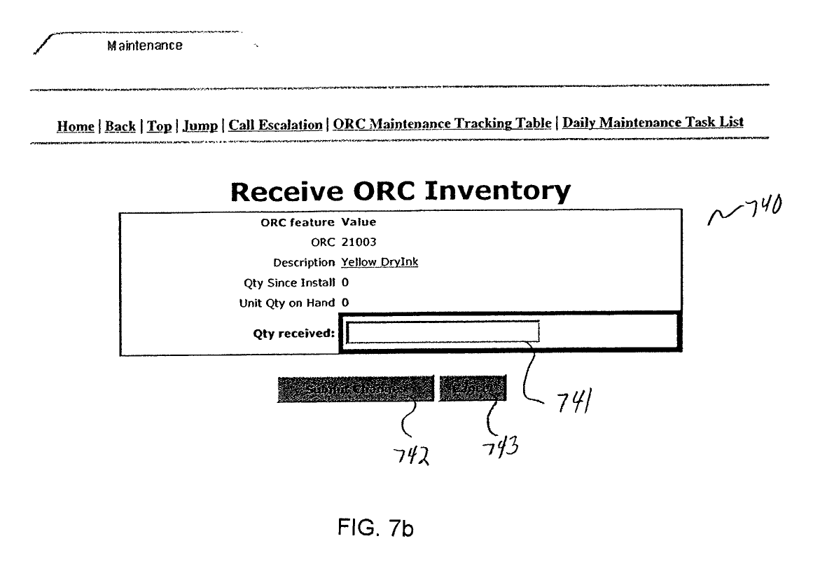

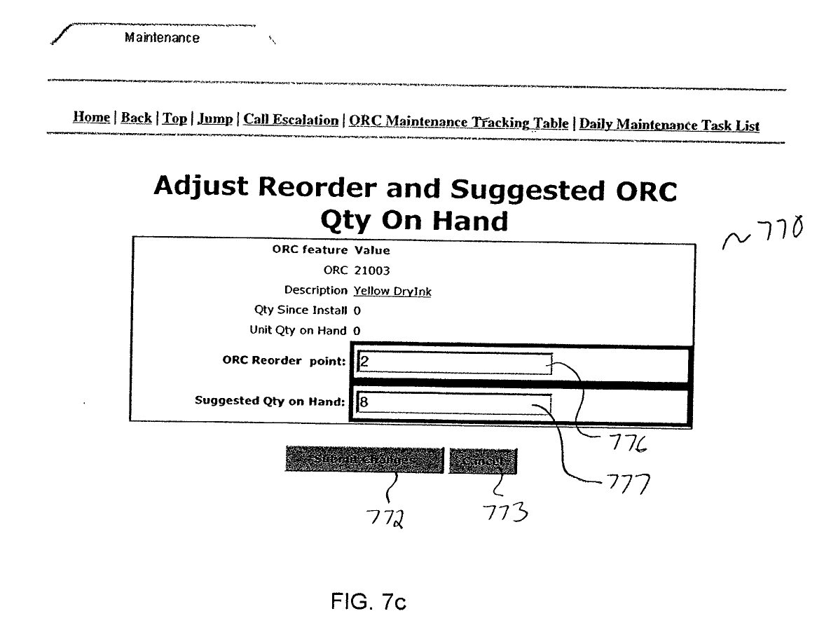

Referring to FIG. 7a, Adjust Inventory Quantity 720 is displayed after the operator clicks on the Adjust ORC Qty 725 button that is shown on the ORC Inventory Part Details 600 screen in FIG. 6. Adjust Inventory Quantity 720 will allow the operator to alter the present number that exists within the inventory for the particular ORC, in this case Yellow DryInk. There is an Adjust Qty field 721 that allows the quantity for that particular ORC to be entered into the inventory. Once a number is placed into the Adjust Qty field 721 and the operator clicks on the Submit Changes 722 button, and the quantity in the Adjust Qty field 721 becomes the total amount in the inventory for that particular ORC device. The previously existing amount in inventory for that ORC device is then erased. If for any reason the operator decides that the current Adjust Inventory Quantity 720 screen is not correct, the operator can press cancel 722 to abort the current operation.

Referring to FIG. 7b, which is an illustration of the Receive ORC Inventory 740 screen that is presented for adjusting details for a specific ORC within inventory once that ORC has been received and has to be entered into inventory, Receive ORC Inventory 740 is displayed after the operator clicks on the Receive ORC 750 button shown on the ORC Inventory Part Details 600 screen in FIG. 6. Receive ORC Inventory 740 allows the operator to enter received stock items into the inventory database by placing the number of that newly received ORC device into the Qty received field 741. Once a number is placed into the Qty received field 741 and the operator clicks on the Submit Changes 742 button, the quantity in the Qty received field 741 is added to the existing amount currently in inventory for that ORC device. If for any reason the operator decides that the current Receive ORC Inventory 740 screen is not correct, the operator can press cancel 742 to abort the current operation.

FIG. 7c is an illustration of the Adjust Reorder and Suggested ORC Qty on Hand 770 screen that is presented for adjusting the reorder details for a specific ORC within inventory that is initiated by the operator clicking on the Set ORC Levels 775 button shown on the ORC Inventory Part Details 600 screen in FIG. 6. The Suggested ORC Qty on Hand 770 screen is used to adjust the thresholds for a specific ORC device (Yellow DryInk in this case) that the inventory management system 500 uses. ORC Reorder Point 776 is a field where the operator can place the number of that specific ORC device that the inventory management system 500 will use to alert the operator that the stock within the inventory for that specific ORC device is dangerously low. Suggested Qty on Hand 777 is a field where the operator can place the quantity of a specific ORC device that is desired to be retained within the inventory at any given time. Once the operator is satisfied that the quantities entered into the field is correct, Submit Changes 772 is pressed and the thresholds that the inventory management system 500 uses for that specific ORC device is updated. If the operator for any reason feels that the Suggested ORC Qty on Hand 770 screen is not the correct screen, initiation of the Cancel 773 button will return operation to the previous screen.

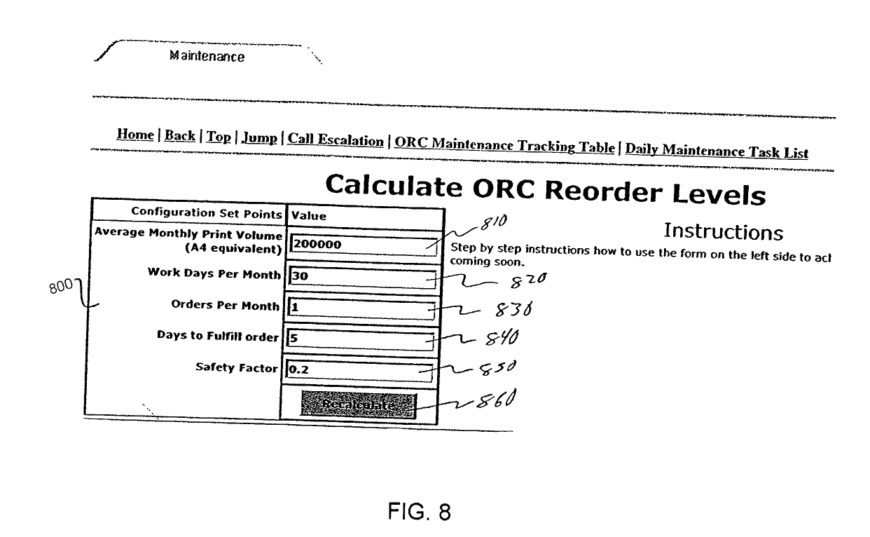

FIG. 8 is an illustration of the Calculate ORC Reorder Levels 800 screen that is presented upon selection from the GUI 106. The Calculate ORC Reorder Levels 800 screen is used by the inventory management system 500 for setting parameters use to calculate levels at which ORC devices are reordered. Average Monthly Print Volume 810 is a field where the operator can adjust the number of prints that the system is estimated to make on a monthly basis. The monthly print volume is important in estimating the overall ORC device usage that will occur on a monthly basis and the Average Monthly Print Volume 810 can be adjusted with varying usage patterns of the printing system. Work Days Per Month 820 is a field that represents the total number of days that the printing system is going to be operating. Orders Per Month 830 is a field that contains the number of times in a month that the inventory will be ordered and restocked. The field Days to Fulfill Order 840 contains the estimated time to receive stock after it has been ordered. Safety Factor 860 is a field that represents a summation of the previously discussed fields in the Calculate ORC Reorder Levels 800 screen. Safety Factor 860 is a measure of assurance that replacement parts will be received within a time frame that will ensure that the printing system will not suffer any down time. The higher the Safety Factor 860 the greater the assurance is that there is sufficient stock within the inventory on hand to ensure that replacement parts will be received without the printing devices 505 suffering any downtime. The operator can insert a desired Safety Factor 850 and the inventory management system 500 will take the desired Safety Factor 850 into account when order forms for replacement parts are generated. The higher the Safety factor that is entered, the greater the number of replacement parts that will be placed on the order sheet. Recalculate 860 is a graphical button that an operator can click on to initiate the recalculation of the automatic order sheet. The automatic order sheet envisioned by the invention is similar to the ORC Recommendation Report shown in Table 3. By clicking on Recalculate 860, the operator takes all the values that have been entered into the fields within the Calculate ORC Reorder Levels 800 screen, and generates an order sheet in accordance with those values.

The inventory management system 500 of the invention is extensible from 1 machine having serviceable components to any number, N, machines maintaining the relationship, whereby, a single inventory is associated with all the machines. The invention associates a single inventory with virtually any number, N, of machines by employing the previously described parameters to manage this single inventory for all the machines employing ORC devices.

The foregoing description has detailed the embodiments most preferred by the inventors. Variations of these embodiments will be readily apparent to those skilled in the art and, accordingly, the scope of the invention should be measured by the appended claims.

What is claimed is:

1. An inventory management system comprising:
at least one piece of equipment having a plurality of components, each of said components having a predictable lifetime;
an inventory of replacement parts for said components;
a computational element operatively coupled to said equipment; and
a mechanism for managing said inventory by tracking said predictable lifetime of said components through usage of said piece of equipment.

2. The inventory management system of claim 1, wherein said computational element further comprises a user interface, said mechanism is coupled to said computational element and said mechanism further comprises an input device that allows entry and deletion of parts within said inventory.

3. The inventory management system of claim 1, wherein at least one of said predictable lifetimes to said components are compared against a threshold that is based on said equipment usage and monitored by said mechanism.

4. The inventory management system of claim 1, wherein said mechanism further comprises:
at least one input from said piece of equipment to said computational element forming said operational coupling, said input providing usage updates on said piece of serviceable equipment;
at least one threshold for each of said components that is compared against usage of said piece of equipment; and
a notification that is triggered when said threshold is reached.

5. The inventory management system of claim 4, wherein said threshold is an accumulated total amount of usage being equal to one of said predictable lifetimes.

6. The inventory management system of claim 1, wherein said mechanism further comprises an inventory notification that is activated when a total number of replacement parts for a specific component within said inventory reaches a predetermined number.

7. The inventory management system of claim 1, wherein said mechanism further comprises a set of parameters related to said predictable lifetime of said components, said set of parameters being used to determine quantities of reorder parts for said inventory.

8. The inventory management system of claim 1, wherein said mechanism for tracking further comprises a set of parameters related to said predictable lifetime of said components, said set of parameters being used to determine a frequency at which reorder of parts for said inventory is made.

9. The inventory management system of claim 8, wherein said set of parameters includes a rate of use of said replaceable components.

10. The inventory management system of claim 1, wherein said piece of equipment is a printing system and said mechanism is coupled to update said inventory with data regarding a remaining page life of said replaceable components, wherein said remaining page life is a value substantially equal to said predictable lifetime minus a printer use value which represents the use of said printing system since said replaceable components have been put into service.

11. The inventory management system of claim 10, wherein said predictable lifetime is a dynamic variable that can change proportionately with use of said printing system.

12. The inventory management system of claim 10, wherein at least one of said predictable lifetimes is computed when one of said replaceable components is taken out of stock and replaced.

13. The inventory management system of claim 10, wherein said mechanism uses a daily printer page count to more accurately predict said inventory needs by tracking said remaining life of said replaceable components.

14. The inventory management system of claim 13, wherein said mechanism manages said inventory for a plurality of printers, and tracks said daily page count for each of said plurality of printers.

15. The inventory management system of claim 10 wherein said mechanism creates said order form for a predetermined number of shipments within a given time period based on a comparison of said remaining life with an expected use parameter.

16. The inventory management system of claim 10, wherein said computational element further comprises as the operative coupling, an integration system that takes said predictable lifetime of said replaceable components, said printer use value and compares these values with stock of said replaceable components within said inventory to provide an analysis for demand of said replaceable components.

17. A method for inventory management comprising the steps of:
providing at least one piece of serviceable equipment item that has a plurality of replaceable components, and also providing an inventory of said replaceable components;
calculating a predetermined life span to each of said replaceable components within said serviceable piece of equipment;
creating a system for tracking said predicted life span of said replaceable components; and
managing said inventory using said system for tracking.

18. The method of inventory management of claim 17, wherein the step of creating further comprises said system for tracking having a set of parameters based on said predicted life span of said replaceable components that is used to determine quantities of reorder parts for said inventory.

19. The method of inventory management of claim 17, wherein the step of creating further comprises said system for tracking having a set of parameters based on said predicted life span of said replaceable components used to determine a frequency at which parts for said inventory are reordered.

20. The method of inventory management of claim 17, wherein the step of creating further comprises said system for tracking having a set of parameters based on said predicted life span of said replaceable components that include a rate of use of said replaceable components and wherein the step of managing further comprises determining a replenishment period for said replaceable components.

21. The method of inventory management of claim 18, wherein the step of providing further comprises said serviceable piece of equipment being a printing system and wherein the creating step further comprises said tracking system being coupled to said inventory to receive data regarding said rate of use for said replaceable components.

22. The method of inventory management of claim 19, wherein the step providing further comprises a printing system as said serviceable equipment item and the step of managing further comprises determining a page life for said replaceable components from said rate of use, is a dynamic variable that can change over time for any of said replaceable components.

23. The method of inventory management of claim 20, wherein the step of managing further comprises said page life is for said replaceable components is computed each time one of said replaceable components is taken out of stock and replaced.

24. The method of inventory management of claim 22, wherein the step of creating further comprises said tracking system tracking a daily page count for each of a plurality of printers.

25. The method of inventory management system of claim 22, wherein the step of managing further comprises integrating said predicted lifespan of said replaceable components, said rate of use and comparing these values with stock of said replaceable components within said inventory to provide an analysis for demand of said replaceable components.
